(19) United States
(12) Patent Application Publication
(10) Pub. No.: US 2025/0292970 A1
(43) Pub. Date: Sep. 18, 2025

(54) CAPACITIVE WINDING OF A DC LINK CAPACITOR AND DC LINK CAPACITOR WITH A COMMON-MODE CURRENT LEAKAGE FUNCTION

(71) Applicant: ZF Friedrichshafen AG, Friedrichshafen (DE)

(72) Inventors: Illia Manushyn, Pegnitz (DE); Igor Lemajic, Friedrichshafen (DE); Benedikt Eller, Hersbruck (DE)

(73) Assignee: ZF Friedrichshafen AG, Friedrichshafen (DE)

(21) Appl. No.: 19/079,797

(22) Filed: Mar. 14, 2025

(30) Foreign Application Priority Data
Mar. 14, 2024 (DE) 10 2024 202 378.7

(51) Int. Cl. H01G 4/32; H01G 2/16; H01G 4/005; H02M 1/44

(52) U.S. Cl. CPC H01G 4/32; H01G 2/16; H01G 4/005; H02M 1/44

(57) ABSTRACT

A capacitive winding for a DC link capacitor has a first metallic layer forming the positive potential and a second metallic layer forming the negative potential, and has at least one section that functions as a return path for common mode current, which is formed by at least one of the metallic layers and is galvanically separated therefrom.

### CROSS-REFERENCE TO RELATED APPLICATION

This application claims priority to German Patent Application No. 10 2024 202 378.7 filed on Mar. 14, 2024, the entirety of which is hereby fully incorporated by reference herein.

### TECHNICAL FIELD

The present invention relates to the field of power electronics.

### BACKGROUND

Power electronics systems are used throughout the world in numerous applications, including electric drive systems for vehicles. One of the main challenges with power electronics systems is the electromagnetic pollution they generate with high frequency disruptions. The undesired high levels of electromagnetic disruptions generated by power electronics converters such as inverters can have a negative impact on adjacent electronic systems and disrupt radio communications. For this reason, these undesired disruptions must be kept to a certain level.

A conventional approach to minimizing electromagnetic emissions is the use of passive electromagnetic compatibility filters (EMC filters). EMC filters can be produced as a module and integrated in the inverter or in other modules in the commutation cell or the control printed circuit board. By way of example, Y-capacitors can be built into DC link capacitors to improve their thermal behavior. A magnetic core could also be used on the phase interface instead of the normal common mode inductor at the DC end. The integrated EMC filter in the form of a separate module, or EMC suppression components in the inverter, typically result in disadvantages such as higher component and production costs and an increase in size and weight.

EMC disruptions can be asymmetrical differential modes or symmetrical common modes. Disruptions in the common modes are caused by semiconductor switching processes and spread out over all conductive elements in the drive system to one or more components with higher stray capacitance, which offer a path to the chassis or ground for the common mode disruption. The common mode disruptions then flow through the chassis to the point in the system where they can return to their origins. The shorter this loop is, the lower the probability of these currents having a negative impact on the functioning of the inverter, thus resulting in lower EMC emissions.

### SUMMARY

An object of the present disclosure is to therefore create an assembly with which common mode disruptions can be reduced.

This problem is solved by the features disclosed herein. Advantageous embodiments are also the subject matter of the present disclosure.

A capacitive winding for a DC link capacitor is created, which has a first metallic layer forming the positive potential and a second metallic layer forming the negative potential, as well as at least one section that functions as a return path for the common mode current, which is formed by at least one of the metallic layers and is galvanically separated therefrom.

In one embodiment, the section forming the return path for the common mode current is galvanically separated from the rest of this layer by a gap passing through the metallic layer.

In one embodiment, the section forming the return path for the common mode current is at one of the ends, or the middle, of the metallic layer.

In one embodiment, the metallic layers are on opposite sides of a single, electrically insulating film. In one embodiment, there are numerous electrically insulating films, and the metallic layers are each on one side of one of the electrically insulating films.

In one embodiment, if there is only one section forming the return path for common mode current, the other metallic layer has a subsection at a point underneath the section forming the return path that is galvanically separated from the metallic layer such that it is only electrically connected to the metallic layer by a connecting web, or by an external connector.

A DC link capacitor formed by numerous capacitive windings is also obtained.

In one embodiment, the number of capacitive windings with sections that form a return path for common mode current in the positive metal layer is the same as the number of capacitive winding with sections that form a return path for common mode current in the negative metallic layer. In one embodiment, the number of capacitive windings with sections that form return paths for common mode current in the positive metallic layer differs from the number of capacitive winding with sections that form return paths for common mode current in the negative metallic layer. In one embodiment, there are only capacitive windings with sections that form return paths for common mode current in the positive or negative metallic layer.

An electronic module is also created that has an inverter and a DC link capacitor electrically connected thereto.

A vehicle that is at least partially powered with electricity is obtained, which has an electronics module in which each part of the capacitive winding in the DC link capacitor that forms a return path for common mode current is in contact with a component that forms a ground.

In one embodiment, the ground is formed by the vehicle chassis or a printed circuit board in the electronics module.

Other features and advantages can be derived from the following descriptions of exemplary embodiments in reference to the drawings showing details thereof, and from the claims. The individual features can be obtained in and of themselves, or in various combinations forming different variations.

Preferred embodiments of the present disclosure shall be explained in greater detail below in reference to the drawings.

### BRIEF DESCRIPTION OF THE DRAWINGS

FIG. 1 shows a schematic illustration of a capacitive winding structure obtained with the present disclosure.

FIGS. 2a, 2b, 3, and 4 each show a schematic illustration of an alternative capacitive winding structure obtained with the present disclosure.

FIG. 5 shows two capacitive windings, each of which has a structure obtained with the present disclosure.

### DETAILED DESCRIPTION

Identical elements and functions have the same reference symbols in the following descriptions of the drawings.

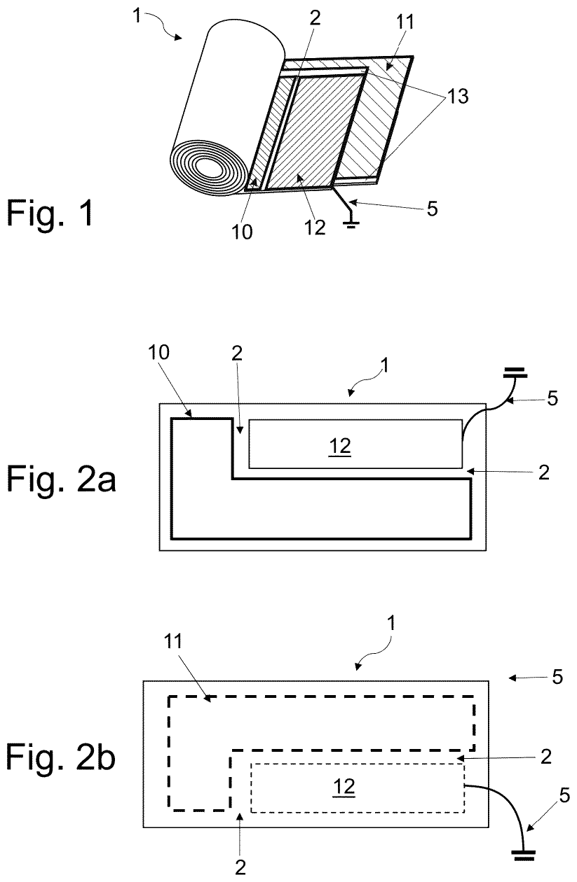

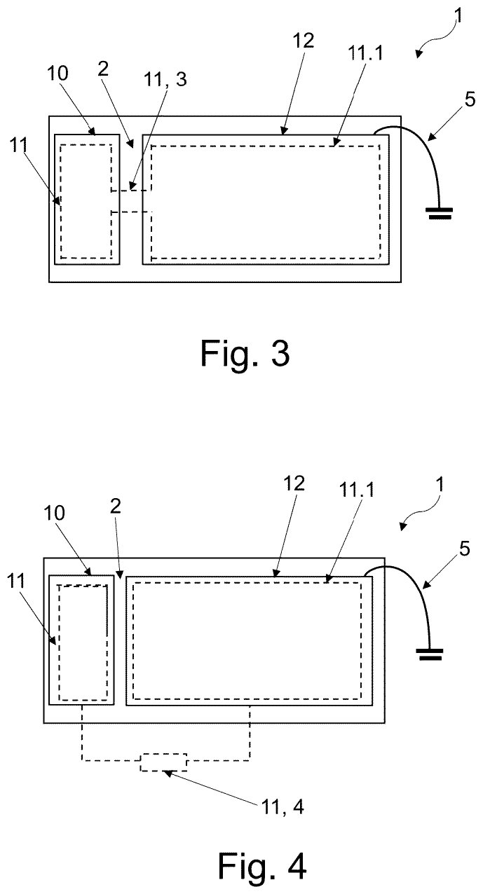

FIGS. 2a, 2b, 3, and 4 are merely schematic illustrations. It should be noted that in these drawings, as well as in FIG. 1, the section on the left is significantly longer than that on the right.

As stated above, the common mode disruptions generated by semiconductor switching processes of power electronics converters such as inverters are a focus of the present disclosure.

An assembly with which the common mode current is shorted near a main common mode current source (power semiconductor) by a ground or chassis is proposed. Consequently, the common modes are unable to spread over a long distance. This requires an adjustment to the DC link capacitor, specifically individual capacitive windings therein, as shall be explained below.

A typical DC link capacitor for automobiles is made of at least one capacitive winding 1 (also referred to below as simply a “winding”) which is wound around a special rod (typically referred to as a mandrel). To create this winding, at least one metal-plated PE film is used, which has a special fuse pattern. These windings are then connected to conductive elements (busbars) (either by soldering or brazing). The overall module is then placed in a housing and encased in a special casting compound.

A DC link capacitor normally has numerous windings 1. Each winding 1 normally has two metallic layers 10, 11, one of which is for the positive potential, and the other is for the negative. The metallic layers 10, 11 are electrically insulated from one another by at least one film 13. One metallic layer 10, 11 can be on one side of the film 13, and the other can be on the other side. In this case, there is an electrically insulating film on the first metallic layer (the first metallic layer 10 in FIG. 1), such that it does not come in contact with the second metallic layer 11 when rolled up. Each metallic layer 10 and 11 can also have a separate film 13. This means that only one side has a metallic layer 10 or 11. In this case, the films 13 are placed on top of one another, and then rolled up. It must be ensured that these metallic layers 10 and 11 do not come in contact with one another. This is obtained by either the orientation of the metallic layers 10 and 11 to one another, or by placing another electrically insulating film between them.

Regardless of how the winding 1 is structured, at least one of the metallic layers 10, 11 is altered by galvanically separating a subsection thereof from the rest of the layer 10, 11. A gap 2 is formed therein for this, which extends to the electrically insulating film 13 on which the metallic layer 10, 11 is formed.

This part of the winding 1 forms the return path for common mode current, instead of the normal power storage function for semiconductor commutation, and satisfying ripple voltage requirements. For this, it is in contact with a ground for the system, in which the DC link capacitor, and therefore the winding 1, is placed, e.g. the vehicle chassis or a printed circuit board, or another component that forms a ground.

A significantly shorter path for the common mode current can be obtained with the section 12 galvanically separated from the positive or negative main sections, which forms a return path for the common mode current and is grounded. This eliminates the need for the previously used Y-capacitors.

The size of the gap 2 separating the main section from the section 12 that forms the return path for common mode current must be determined such that this section 12 is the same size or greater than the coupling capacitor for the load or source, i.e. the motor control capacitor in the case of a motor, because it is proportional thereto.

The section 12 forming the return path can be formed at one end (where the roll ends) as shown in FIG. 1, or the other (where the roll starts). It can also be in the middle, as long as it is possible to obtain an electrical contact there.

In the embodiments shown in FIGS. 1, 3 and 4, the section 12 forming the return path is simply formed in one of the metallic layers 10, 11. It can also be formed in both layers 10, 11, as shown in FIGS. 2a (upper surface of the film) and 2b (lower surface of the film). These layers 10, 11 do not have to extend over the entire width of a subsection, thus forming an L-shaped section. This section 12 forming the return path can be parallel to the leg of the L-shaped section. It is then separated from the metallic layer 10, 11 by two gaps 2.

The same pattern used with conventional DC link capacitors can be used on the metallic layers 10, 11, to prevent a short circuiting between one of the conductive parts and the chassis, and satisfy safety requirements. The aim of a fuse pattern is to interrupt the current path if part of the film becomes damaged, thus isolating this area from the rest of the capacitor. This prevents a short circuit between positive and negative potentials and the chassis.

In one embodiment, an additional safeguard can be added by reducing the width of the current path in part of the metallic layer 10, 11, as indicated in the different embodiments shown in FIGS. 3 and 4. In this case, a subsection 11.1 of the metallic layer (layer 11 in FIGS. 3 and 4) is separated from the rest by a gap 2. This subsection 11.1 is not grounded, and instead is reconnected to the main part by a fuse. This minimizes the risk of a short circuit between the positive and negative potentials and the chassis. The size of the subsection 11.1 in one embodiment is such that it corresponds to the section 12 forming the return path, i.e. they are approximately the same size. FIG. 3 shows an embodiment in which a connecting web 3 remains between the separated section and the main section. In this case, there is no gap 2 in the metallic layer 11. FIG. 4 shows an embodiment in which the gap 2 passes entirely through the layer, and an external (electrical) connection is obtained between the separated section and the main section, in which there is an external connector 4 that has the same function as the web 3, specifically that of a fuse.

The fuse can be used in all of the embodiments of the present disclosure. By way of example, it is formed in the metallic layer 10 or 11 (layer 11 in the embodiments shown herein) in the embodiments shown in FIGS. 3 and 4, which do not have a separated section 12 forming the return path for common mode current. In the embodiments shown in FIGS. 2a and 2b, the legs of the metallic layers 10, 11 can also be separated from the main sections thereof by a gap 2, and connected to one another by a fuse 3 or 4.

The fuse can also be used to optimize the equivalent serial resistance, and potentially dampen certain system resonances in the spectrum. The fuse pattern can also be designed such that the serial resistance can be adjusted serially to the capacitance. A screw can also be used to adjust the dampening of the system resonances in the spectrum.

As stated above, a DC link capacitor is normally formed by numerous windings 1 connected to one another, forming the capacitive windings of the DC link capacitor, and in electrical contact with corresponding busbars. If these windings 1 with modified metallic layers 10, 11 are then used in a DC link capacitor, there is no longer any need for Y-capacitors, because their function has been replaced by the modified windings 1.

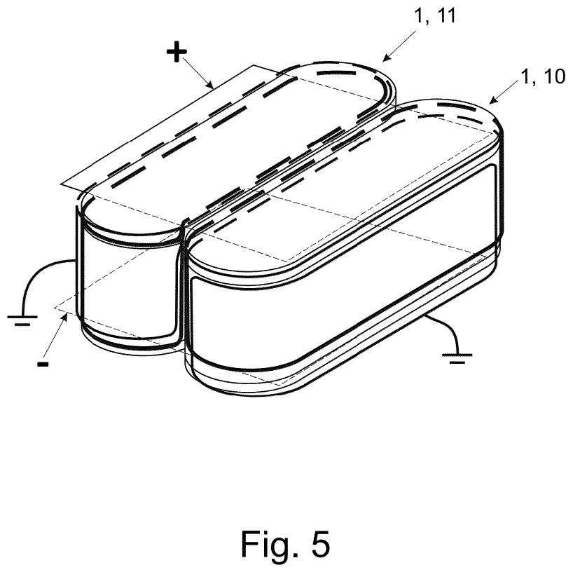

In an advantageous embodiment, at least two capacitive windings are used, in which the section 12 forming the return path is symmetrically divided between the windings 1, i.e. each winding has a different potential (positive +or negative-), as indicated in FIG. 5. By way of example, the positive metallic layer on the first winding remains intact, while the negative metallic layer is interrupted, such that this section can be connected to the chassis or ground. The negative potential in the second winding remains unchanged, but the positive metallic layer is interrupted and connected to the chassis. This balances the two potentials from the perspective of the common mode current. This prevents common mode current from being converted to differential modes, which could also cause undesired resonances in the disruption spectrum. This can also be applied to all other winding designs, i.e. those in which both metallic layers 10, 11 are modified, thus having a section 12 forming a return path for common mode current. The size of the windings 1 in the DC link capacitor may vary as well.

The number of windings 1 with sections 12 forming return paths for common mode current in the positive metallic layer can also be less than or greater than the number of film capacitors 1 with sections 12 forming return paths in the negative metallic layer. Furthermore, there can be windings 1 with sections 12 forming return paths in only the positive or negative metallic layer.

By using these windings 1 with which common mode current can be removed over a short path, a complete DC link capacitor can be formed. The overall DC link capacitor and the capacity in relation to the ground must be designed in accordance with the requirements of the system. The connection from the section 12 forming the return path for common mode current to the chassis or ground must be obtained with a connector 5, e.g. a pin, wire, or bus bar, which is attached to the capacitive windings (section 12), e.g. through soldering or brazing.

Through the proposed modification of the metallic layer(s) 10, 11 with windings 1 used for a DC link capacitor, a short circuit can take place in the common mode current to the chassis or ground near its source. This prevents spreading of this current throughout the system and disrupting other functional modules. Furthermore, a higher-order high-frequency damping above 10 MHz, including VHF, can be obtained. The parasitic inductivity is at least twice as low as with typical windings, because there is no continuity.

The capacitance to the ground can be modified in a simple manner by the selection of the size of the section 12 and the gap 2, without having to mechanically modify the inverter. This simplifies satisfying system requirements and alterations.

This can also be easily integrated in mass production, because a typical winding for a DC link capacitor, with only slight adjustments in the metallic layer where the ground capacitor is integrated, can be used.

A high level of integration is also obtained, thus reducing costs, size and weight of the system. With this design, additional components such as Cy, or the entire DC EMC filter module can be eliminated, having a positive effect on the overall costs, weight, and size of an inverter.

It is also possible to adjust resonances in the high voltage artificial network (HVAN) spectrum. The resonances in this spectrum can be manipulated by adjusting the amplitude and/or frequency of the common mode current. This can be achieved with the proposed principle.

A main indicator for whether the proposed modified winding 1 can be used is how critical the common mode current in the system is. This problem is typical with all systems that have a B6 bridge, and many types of multi-step inverters, DC inverters, active rectifiers, etc.

These power electronics systems, i.e. systems with semiconductors functioning as switches, are used in different fields, e.g. adjustable drives, systems for obtaining electricity, chargers, inductive power transmission systems, high-voltage DC power transfer lines, aircraft power supply systems, switch-mode power supplies and, not least of all, electric mobility.

There is normally an electronics module in electric mobility, which is used to power an electric drive for a motor vehicle powered by batteries or fuel cells. The motor vehicle can be a utility vehicle, e.g. a truck or bus, or it can be a passenger automobile. The electronics module contains an inverter and a DC link capacitor, as well as other components such as an EMC filter, heat sink, AC/DC rectifier, DC/DC converter, direct AC-AC cycloconverter or matrix converter, and/or other electrical converters. In particular, the power electronics module supplies electricity to an electric machine, e.g. an electric motor and/or generator. A DC/AC inverter is preferably used to generate a multi-phase alternating current from a direct current generated from a DC voltage from a power source such as a battery. A DC/DC converter is used to convert (increase) a direct current form a fuel cell into a direct current that can be used by the drive.

### LIST OF REFERENCE SYMBOLS

1 winding
10 first metallic layer
11 second metallic layer
11.1 subsection
12 section forming the return path for common mode current (ground)
13 electrically insulating film
2 gap
3 connecting web (fuse)
4 external connector (fuse)
5 connector to ground/chassis

1. A capacitive winding for a DC link capacitor, comprising:
a first metallic layer forming a positive potential;
a second metallic layer forming a negative potential; and
at least one section configured to function as a return path for common mode current, which is formed by at least one of the first and/or second metallic layers and is galvanically separated therefrom.

2. The capacitive winding according to claim 1,
wherein the at least one section configured to function as the return path for common mode current is galvanically separated from the rest of the first and/or second metallic layer by at least one gap passing through the first and/or second metallic layer.

3. The capacitive winding according to claim 1,
wherein the at least one section configured to function as the return path for common mode current is at one of an end or a middle of the first and/or second metallic layer.

4. The capacitive winding according to claim 1, comprising:
an electrically insulating film, wherein the first and second metallic layers are on opposite sides of the electrically insulating film.

5. The capacitive winding according to claim 1, comprising:
a plurality of electrically insulating films, wherein the first and second metallic layers are each on one side of one of the plurality of electrically insulating films.

6. The capacitive winding according to claim 1,
wherein the at least one section comprises just one section configured to function as the return path for common mode current in one of the first or second metallic layers,
wherein another of the first or second metallic layers has a subsection at a position underneath the one section configured to function as the return path for common mode current, which is galvanically separated from the first and/or second metallic layers, such that it is electrically connected to the first and/or second metallic layer by a connecting web or by an external connector.

7. A DC link capacitor comprising:
a plurality of the capacitive windings according to claim 1.

8. The DC link capacitor according to claim 7,
wherein a number of capacitive windings with the sections configured to function as the return path for common mode current in the first metallic layer forming the positive potential is equal to a number of capacitive windings with the sections configured to function as the return path for common mode current in the second metallic layer forming the negative potential.

9. The DC link capacitor according to claim 7,
wherein a number of capacitive windings with the sections configured to function as the return path for common mode current in the first metallic layer forming the positive potential is greater than or less than a number of capacitive windings with the sections configured to function as the return path for common mode current in the second metallic layer forming the negative potential.

10. The DC link capacitor according to claim 7,
wherein there are only capacitive windings with the sections configured to function as the return path for common mode current in the first metallic layer forming the positive potential, or there are only capacitive windings with the sections configured to function as the return path for common mode current in the second metallic layer forming the negative potential.

11. An electronics module comprising:
an inverter; and
the DC link capacitor according to claim 7 that is electrically connected to the inverter.

12. A vehicle that is at least partially powered with electricity, comprising:
an electronics module according to claim 11,
wherein each of the sections of the capacitive windings in the DC link capacitor that are configured to function as the return path for common mode current is in contact with a component that forms a ground.

13. The vehicle according to claim 12, wherein the component that forms the ground is a vehicle chassis or a printed circuit board in the electronics module.
